(19) United States
(12) Patent Application Publication
(10) Pub. No.: US 2013/0259981 A1
(43) Pub. Date: Oct. 3, 2013

(54) FROZEN GYOZA AND REFRIGERATED GYOZA WITH BROWNING AGENT, AND METHOD FOR PRODUCING THE SAME

(71) Applicant: AJINOMOTO CO., INC., Chuo-ku (JP)

(72) Inventors: Shogo HIRAE, Oura-gun (JP); Keisuke IMAIZUMI, Oura-gun (JP); Tomomi TAMAIGO, Oura-gun (JP); Nobuhiro SHITARA, Oura-gun (JP)

(73) Assignee: AJINOMOTO CO., INC., Chuo-ku (JP)

(21) Appl. No.: 13/835,245

(22) Filed: Mar. 15, 2013

(30) Foreign Application Priority Data
Mar. 30, 2012 (JP) 2012-082022

(51) Int. Cl. A23L 1/272

(52) U.S. Cl. CPC A23L 1/272
USPC 426/95; 426/262; 426/94

(57) ABSTRACT

Frozen or refrigerated gyoza having an improved quality can be produced by forming a layer of a browning agent on a portion of a gyoza, such that the browning agent has a net-like structure and the structure properties of the net-like structure is used as an index.

### CROSS REFERENCES TO RELATED APPLICATIONS

This application claims priority to Japanese Patent Application No. 2012-082022, filed on Mar. 30, 20123, which is incorporated herein by reference in its entirety.

### BACKGROUND OF THE INVENTION

1. Field of the Invention

The present invention relates to frozen gyoza and refrigerated gyoza with a browning agent, and methods for producing the same.

2. Discussion of the Background

As for a usual method for cooking gyoza, uncooked or steamed gyoza dumplings, or frozen or refrigerated uncooked or steamed gyoza dumplings are arranged in an iron pot or the like with an oil covering the bottom thereof and then steam-baked. However, according to this method, the number of gyoza dumplings which can be cooked at one time is limited, and therefore, it is difficult to cook a large number of gyoza dumplings in a short time and also there is a problem that skill is required for nicely browning a surface of gyoza. There is also a problem that after completion of the cooking, the browned surface becomes soft over time and the crisp texture and savory flavor immediately after cooking are significantly deteriorated.

Therefore, a method for producing gyoza, which enables anybody to cook a large amount of gyoza easily, and also achieves uniform browning of a surface to be browned of gyoza and enables the production of gyoza having a texture and a savory flavor close to those immediately after cooking by attaching an emulsion having a specific composition to a surface to be browned of gyoza, followed by steam-baking, was developed (see Japanese Patent No. 2850690). Further, a study of the composition of the emulsion to be attached was further advanced, and a technique for preventing individual gyoza dumplings from being out of position during transportation, etc. were also developed (see Japanese Patent No. 4483268).

However, according to these methods, after cooking, burnt debris remains in a frying pan or the like, or an unbaked portion remains on gyoza in some cases, and further, depending on the composition of a browning agent or the production method, the texture of the resulting gyoza is not favorable in some cases, and therefore, further improvement of the quality of gyoza has been demanded.

Thus, there remains a need for improved frozen gyoza and refrigerated gyoza,

### SUMMARY OF THE INVENTION

Accordingly, it is one object of the present invention to provide novel frozen or refrigerated gyoza.

It is another object of the present invention to provide novel frozen or refrigerated gyoza with a browning agent.

It is another object of the present invention to provide novel frozen or refrigerated gyoza with a browning agent, which reduces burnt debris generated when cooking the gyoza by steam-baking.

It is another object of the present invention to provide novel frozen or refrigerated gyoza with a browning agent, which prevents the occurrence of an unbaked portion of the browning agent.

It is another object of the present invention to provide novel frozen or refrigerated gyoza with a browning agent, which affords a browned surface with a favorable texture regardless of the composition of the browning agent.

It is another object of the present invention to provide novel methods for producing such a frozen or refrigerated gyoza.

These and other objects, which will become apparent during the following detailed description, have been achieved by the inventors' discovery that the net-like structure of the browning agent and the quality of the gyoza are associated with each other. Further, the inventors have found that by preparing the browning agent using the number of connection points in the net-like structure per unit area (mm²) (a structure value A) of the fine net-like structure seen in a frozen section of the browning agent and the sum of the lengths of center lines of structural bodies of the net-like structure per unit area (mm²) (a structure value B) as indices, the quality of frozen gyoza can be significantly improved.

Thus, the present invention provides:

(1) A method for producing frozen or refrigerated gyoza with a browning agent, characterized in that a browning agent is prepared using a net-like structure of the browning agent as an index.

(2) The method for producing frozen or refrigerated gyoza according to the above (1), wherein the browning agent is prepared using the number of connection points in the net-like structure per unit area (mm²) (a structure value A) of the browning agent and the sum of the lengths of center lines of structural bodies of the net-like structure per unit area (mm²) (a structure value B) of the browning agent as indices.

(3) The method for producing frozen or refrigerated gyoza according to the above

(2), wherein the browning agent is prepared such that the structure value A of the browning agent when the thickness of a section of the browning agent is set to 20 μm is from 20 to 90 (points/mm²).

(4) The method for producing frozen or refrigerated gyoza according to the above (2) or (3), wherein the browning agent is prepared such that the structure value B of the browning agent when the thickness of a section of the browning agent is set to 20 μm is 30 (mm/mm²) or less.

(5) Frozen or refrigerated gyoza with a browning agent, produced by the production method according to any one of the above (1) to (4).

(6) Frozen or refrigerated gyoza with a browning agent, characterized in that the number of connection points in a net-like structure per unit area (mm²) (a structure value A) of a browning agent when the thickness of a section of the browning agent is set to 20 μm is from 20 to 90, and the sum of the lengths of center lines of structural bodies of the net-like structure per unit area (mm²) (a structure value B) of the browning agent when the thickness of a section of the browning agent is set to 20 μm is 30 mm or less.

According to the method for producing frozen or refrigerated gyoza with a browning agent of the present invention, frozen or refrigerated gyoza having an improved quality can be produced by preparing a browning agent using a net-like structure of the browning agent formed on the gyoza as an index. Further, the frozen gyoza and refrigerated gyoza with a browning agent of the invention are frozen gyoza and refrigerated gyoza with a browning agent, which reduce burnt debris generated when cooking the gyoza by steam-baking, prevent the occurrence of an unbaked portion of the browning agent, and also form a browned surface with a favorable texture when cooking the gyoza by steam-baking, and therefore have a high quality.

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 is a is a schematic diagram of a fine net-like structure of a browning agent formed on a surface of frozen gyoza with the browning agent.

FIGS. 2A to 2D are microscopically enlarged photographs of frozen sections of browning agents prepared in Examples. FIG. 2A shows a microscopically enlarged view of a net-like structure of a frozen section of a browning agent when a browning agent prepared under the conditions of an experimental group 26 was used; FIG. 2B shows a microscopically enlarged view of a net-like structure of a frozen section of a browning agent when a browning agent prepared under the conditions of an experimental group 27 was used; FIG. 2C shows a microscopically enlarged view of a net-like structure of a frozen section of a browning agent when a browning agent prepared under the conditions of an experimental group 30 was used; and FIG. 2D shows a microscopically enlarged view of a net-like structure of a frozen section of a browning agent when a browning agent prepared under the conditions of an experimental group 23 was used.

FIGS. 3A to 3J are graphs showing a relationship between a structure value A or B of a net-like structure of a browning agent and a preparation condition for the browning agent or a steam-heating condition for gyoza. FIGS. 3A and 3B show an effect of a change in stirring condition when preparing the browning agent on structure values A and B, respectively; FIGS. 3C and 3D show an effect of a change in steam-heating time for gyoza on the structure values A and B, respectively; FIGS. 3E and 3F show an effect of a change in steam-heating temperature for gyoza on the structure values A and B, respectively; FIGS. 3G and 3H show an effect of a change in weight ratio of water to oil in the browning agent on the structure values A and B, respectively; and FIGS. 3I and 3J show an effect of a change in temperature when mixing ingredients of the browning agent on the structure values A and B, respectively.

FIG. 4 is a table showing what measures can be taken when the structure value A or B of a browning agent of prepared gyoza is outside a predetermined numerical range along with the cause thereof.

### DETAILED DESCRIPTION OF THE PREFERRED EMBODIMENTS

### Evaluation of Net-Like Structure of Browning Agent

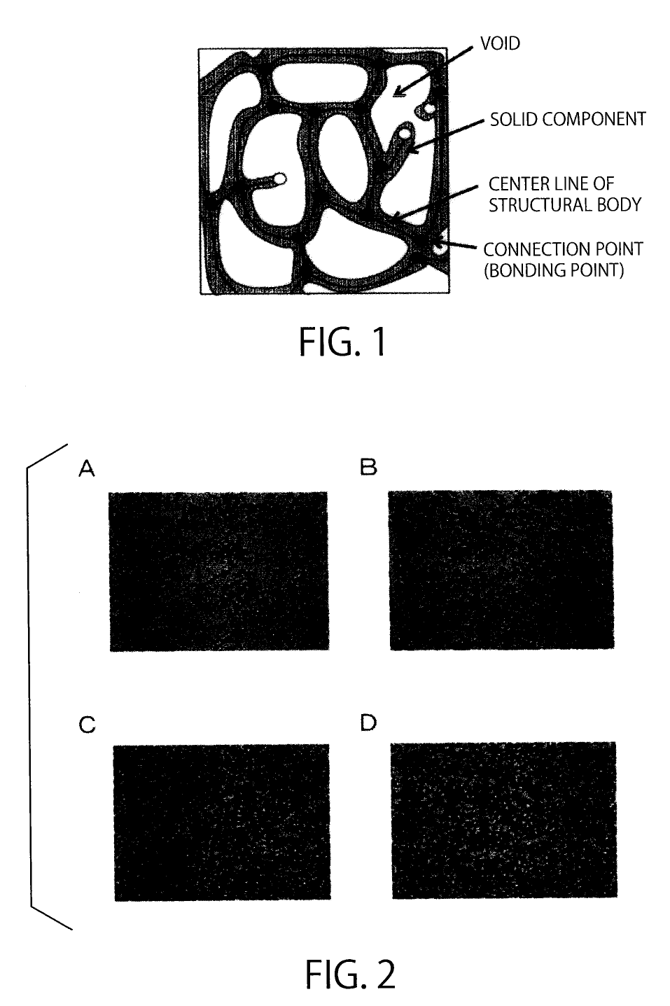

As described in the following Examples, the present inventors found that a browning agent attached to a gyoza main body forms a net-like structure (see FIG. 1), and also found that by preparing frozen gyoza such that the browning agent forms a specific net-like structure, the quality of frozen gyoza can be improved (in other words, burnt debris generated when cooking the gyoza by steam-baking can be reduced, the occurrence of an unbaked portion of the browning agent can be prevented, and a browned surface with a favorable texture when cooking the gyoza by steam-baking can be formed). That is, the method for producing frozen or refrigerated gyoza with a browning agent of the invention is characterized in that a browning agent is prepared using the net-like structure of the browning agent formed on a surface of frozen or refrigerated gyoza as an index.

As the net-like structure to be used as the index, the number of connection points in the net-like structure per unit area (mm²) of the net-like structure (a structure value A) and the sum of the lengths of center lines of structural bodies of the net-like structure per unit area (mm²) (a structure value B) can be exemplified. Here, the structure value A corresponds to the number of connection points (bonding points) per unit area (points/mm²) in FIG. 1, and the structure value B corresponds to the sum of the lengths (mm) of center lines of structural bodies per unit area in FIG. 1. In the present invention, by adjusting the structure value A and/or the structure value B to a specific value, the quality of frozen or refrigerated gyoza can be improved.

The net-like structure of the browning agent can be observed, for example, as follows. First, the browning agent formed on the gyoza main body is transformed into a frozen state, and the frozen browning agent is cut into a section with an appropriate size (for example, 1 cm square). Then, the section is fixed by being impregnated with a fixative solution (for example, a Ufix solution manufactured by Sakura Finetek Co., Ltd.) whose temperature is adjusted to −25° C. Thereafter, the fixed frozen section is degreased by being immersed in hexane at −25° C. Subsequently, the degreased section is immersed in a 10% sucrose solution at 4° C., and then immersed in a 20% sucrose solution. The sucrose solution to be used at this time preferably contains a 1% iodine solution for coloring. Thereafter, the section is embedded in 4% carboxymethyl cellulose, frozen at −25° C., and then cut into a section with a thickness of 20 μm using a microtome. After the thus obtained section is air-dried on a slide glass, the observation of the section can be performed using a light microscope.

The structure values A and B which can be used as the indices in the invention can be obtained by, for example, scanning an enlarged image of the frozen section obtained by a light microscope into a computer, and analyzing the scanned image by the computer, followed by calculation. Prior to the analysis, it is preferred to binarize the image scanned into the computer to black and white, and the binarized parameters can be appropriately set by those skilled in the art. In addition, after the binarization, processing such as noise removal can be further performed.

The structure values A and B may be obtained by an image analysis using trabecular bone structure analysis software. As the trabecular bone structure analysis software, any software may be used as long as it is a commercially available one, however, for example, the structure values A and B can be obtained using an algorithm of 2-D bone analysis of the trabecular bone structure analysis according to the manufacturer's manual. As the algorithm of 2-D bone analysis of the trabecular bone structure analysis, an algorithm based on the node-strut method (Uchiyama et al., “Method for Evaluating Trabecular Structure in Bone Tissue Morphometry”, J. Jpn. Soc. Bone Morphom., vol. 4, pp. 83-89, 1994, which is incorporated herein by reference in its entirety) can be used.

In the production method of the present invention, by preparing the browning agent so as to form a browning agent which has a structure value A in a range of from 20 to 90 (preferably in a range of from 20 to 80, more preferably from 22 to 70 points/mm²) when the thickness of a section of the browning agent is set to 20 μm, the quality of frozen or refrigerated gyoza can be improved. The structure value A can be calculated from a frozen section of the browning agent as described above.

In the production method of the present invention, by preparing the browning agent so as to form a browning agent which has a structure value B of 30 or less (preferably in a range of from 5 to 30, more preferably from 8 to 30 mm/mm²) when the thickness of a section of the browning agent is set to 20 μm, the quality of frozen or refrigerated gyoza can be improved. The structure value B can be calculated from a frozen section of the browning agent as described above.

In the production method of the present invention, the browning agent can be prepared using both of the structure values A and B of the browning agent when the thickness of a section of the browning agent is set to 20 μm as indices. Therefore, according to the invention, a method for producing frozen or refrigerated gyoza with a browning agent, characterized in that a browning agent is prepared so as to form a browning agent which has a structure value A of from 20 to 90 points/mm² when the thickness of a section of the browning agent is set to 20 μm and has a structure value B of 30 or less mm⁻¹ when the thickness of a section of the browning agent is set to 20 μm is provided. According to this method, the quality of the produced frozen or refrigerated gyoza can be further more improved.

### Preparation of Browning Agent.

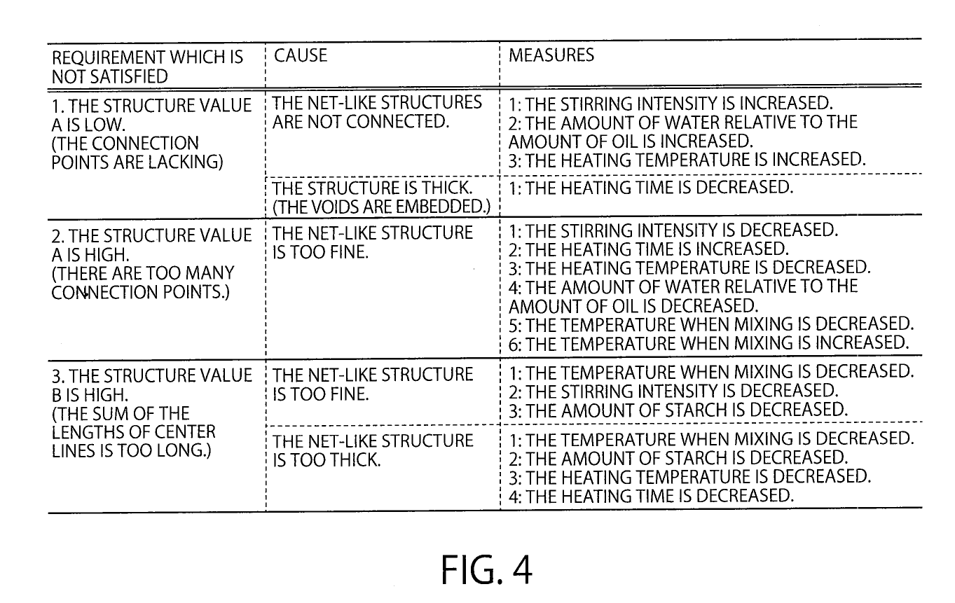

As described in the following Examples, the present inventors found that by changing the preparation conditions for the browning agent, the structure values A and B can be controlled and also the quality of frozen gyoza can be improved (see FIG. 4). Therefore, in the production method of the present invention, the production conditions are determined by changing the preparation conditions for the browning agent using the structure values A and B of the browning agent as indices, and frozen or refrigerated gyoza having an improved quality can be produced. Examples of the preparation conditions which can be changed include the stirring intensity (stirring speed and stirring time) when mixing the ingredients of the browning agent, the temperature when mixing the ingredients of the browning agent, the ratio of water to oil to be used as the ingredients of the browning agent, the ratio of the amount of a starch in the ingredients of the browning agent, and steam-heating conditions (heating temperature and heating time) after integrating the browning agent and uncooked gyoza with each other.

Specifically, in the case where the structure value A is lower than the numerical range serving as the index, the structure value A can be increased by increasing the stirring intensity, increasing the ratio of water to oil, and/or increasing the heating temperature. Further, in the case where the structure value A is higher than the numerical range serving as the index, the structure value A can be decreased by decreasing the stirring intensity, increasing the heating time, decreasing the heating temperature, decreasing the ratio of water to oil, and/or decreasing or increasing the temperature when mixing the ingredients of the browning agent. Further, in the case where the structure value B is higher than the numerical range serving as the index, the structure value B can be decreased by decreasing the stirring intensity when mixing the ingredients of the browning agent, decreasing the temperature when mixing, decreasing the amount of starch, decreasing the heating temperature, and/or decreasing the heating time. Further, in the case where the structure value B is lower than the numerical range serving as the index, the structure value B can be increased by increasing the stirring intensity when mixing the ingredients of the browning agent, increasing the temperature when mixing, and/or decreasing the ratio of water to oil. In this manner, in the case where the structure values A and B do not fall within the predetermined numerical ranges, by changing the preparation method for the browning agent such as the composition of the browning agent, the stirring conditions and the temperature conditions when preparing the browning agent, and the steam-heating conditions (the heating temperature and the heating time) after integrating the browning agent and uncooked gyoza with each other, frozen or refrigerated gyoza on which the browning agent having predetermined structure values A and B has been formed can be produced.

Accordingly, the production method of the present invention may further include a step selected from the group consisting of:

a) adjusting the composition of the ingredients of the browning agent;

b) adjusting the stirring intensity when mixing the ingredients of the browning agent;

c) adjusting the temperature when mixing the ingredients of the browning agent;

d) adjusting the ratio of water to oil in the browning agent;

e) adjusting the steam-heating time for the browning agent and the gyoza main body; and

f) adjusting the steam-heating temperature for the browning agent and the gyoza main body; and

g) an arbitrary combination of the above a) to f).

According to this, frozen or refrigerated gyoza with a browning agent can be prepared so that the structure values A and B of the browning agent fall within the predetermined numerical ranges, and therefore, frozen or refrigerated gyoza having an improved quality can be produced.

### Production of Frozen Gyoza and Refrigerated Gyoza.

The production method of the present invention can be performed according to a common method for producing frozen gyoza with a browning agent or a common method for producing refrigerated gyoza with a browning agent except that the browning agent is prepared using the net-like structure of the browning agent as an index.

For example, as for the method for producing frozen gyoza of the invention, uncooked gyoza to which a browning agent (for example, a batter) has been attached is steam-heated, and then quickly frozen, whereby frozen gyoza with a browning agent can be produced. In the case where the net-like structure of the browning agent is analyzed, the analysis may be performed after the browning agent is obtained from the frozen gyoza after quick-freezing, or after the browning agent is obtained from the gyoza before quick-freezing, and then transformed into a frozen section.

As for the method for producing refrigerated gyoza of the present invention, for example, uncooked gyoza to which a browning agent (for example, a batter) has been attached is steam-heated, and then quickly refrigerated, whereby refrigerated gyoza with a browning agent can be produced. In the case where the net-like structure of the browning agent is analyzed, the analysis can be performed after the browning agent is obtained from the produced refrigerated gyoza, and then transformed into a frozen section.

In the invention, the term “gyoza” is not particularly limited and is used in the sense of including a food obtained by wrapping a filling containing ground pork, minced Chinese cabbage, minced Welsh onion, minced ginger, seasonings, etc., which are mixed with one another, with a dough piece obtained by kneading a cereal flour such as wheat flour to prepare a dough and molding the dough into a disk-shaped piece, followed by heating. Specific examples of the “gyoza” include wild boar gyoza (pork gyoza), chicken gyoza, beef gyoza, mutton gyoza, fish gyoza, shrimp gyoza, and dessert gyoza.

Further, in the invention, the term “frozen gyoza” refers to gyoza in the frozen form obtained by processing so that gyoza can be simply cooked. The frozen gyoza can be cooked by, for example, steam-baking using water and if necessary, a small amount of oil.

Further, in the present invention, the term “refrigerated gyoza” is used in the sense of including “chilled gyoza”, and refers to gyoza in the refrigerated form obtained by processing so that gyoza can be simply cooked. The refrigerated gyoza can be cooked by, for example, steam-baking using water and if necessary a small amount of oil in the same manner as the frozen gyoza.

In the present invention, the “browning agent” formed on a surface of gyoza constitutes a portion of the frozen or refrigerated gyoza of the invention, and in the case where the frozen or refrigerated gyoza is cooked by steam-baking in a frying pan or a hot plate, the browning agent forms a browned surface suitable for baked gyoza on a surface of the gyoza, and also forms a “crispy edge” around the gyoza. That is, by forming the browning agent on a surface of gyoza, the crisp texture of the browned surface and the savory texture when cooking the gyoza can be improved, and also the appearance thereof can be improved.

The method for attaching the browning agent to gyoza is not particularly limited. However, for example, a method in which gyoza is dipped in the browning agent, a method in which the browning agent is applied to gyoza using a brush or a roller, a method in which the browning agent is applied to gyoza using a sprayer, or the like can be used. Specifically, the method in which gyoza is dipped in the browning agent can be performed by arranging gyoza dumplings in a tray and pouring the browning agent on the bottom of the tray, or by arranging gyoza dumplings in a tray in which the browning agent has been poured. In this case, by arranging the gyoza dumplings in the tray such that a surface to be browned of the gyoza becomes the bottom, the browning agent can be formed on the surface to be browned of the gyoza, and the texture of the browned surface of the gyoza can be further more improved.

In a preferred embodiment, one side of the gyoza is coated with 0.0001 to 0.0040 g/mm², preferably from 0.0001 to 0.0020 g/mm², more preferably from 0.0001 to 0.0010 g/mm², of the browning agent.

In a preferred embodiment, the gyoza has a coating of browning agent in an amount of 0.1 to 30% by weight, preferably 1 to 10% by weight, based on the amount of the gyoza having the browning agent.

In a preferred embodiment, a portion of the gyoza has a coating of browning agent having a thickness of 0.1 to 4.0 mm, preferably 0.1 to 2.0 mm, more preferably 0.1 to 1.0 mm.

In the present invention, as the browning agent to be attached to a surface of gyoza, a batter can be exemplified, and for example, a material containing water, a starch, and a protein, and if necessary, a cooking oil, an emulsifier, and/or a seasoning can be used as the “batter”. Further, the batter may be an emulsified batter, and for example, a material containing water, a cooking oil, an emulsifier, a starch, and a protein, and if necessary, a seasoning can be used as the “emulsified batter”. In the case where the batter is used in the production method of the invention, the ingredients of the batter are mixed and stirred to obtain a batter liquid. Then, the obtained batter liquid is attached to a surface of gyoza, and if necessary steam-heating is performed, whereby frozen or refrigerated gyoza with a browning agent can be produced. Incidentally, as described above, by adjusting the composition of the browning agent, adjusting the stirring speed or temperature when mixing the ingredients of the browning agent, or adjusting the steam-heating time or the steam-heating temperature for the browning agent and the gyoza main body, the browning agent formed on a surface of gyoza can be made to have predetermined structure values A and B, and therefore, from these points of view, the composition of the batter or the preparation conditions therefor may be determined.

Water to be used in the batter can be blended in an amount of from 10 to 99% by weight, preferably from 30 to 90% by weight, based on the amount of the batter.

The cooking oil which can be used in the batter is not particularly limited as long as it is an edible oil, however, examples thereof include canola oil, soybean oil, corn oil, safflower oil, lard, shortening, butter, and palm oil. The cooking oil can be blended in an amount of from 0 to 90% by weight, preferably from 0 to 60% by weight, based on the amount of the batter. Incidentally, as described above, by adjusting the ratio of water to oil in the browning agent, the browning agent formed on a surface of gyoza can be made to have predetermined structure values A and B, and therefore, from these points of view, the amount of the cooking oil to be used in the batter may be determined.

The emulsifier which can be used in the batter is not particularly limited as long as it is edible, however, examples thereof include lecithin, a propylene glycol fatty acid ester, monoglycerol, and a sugar ester. The emulsifier can be blended in an amount of from 0.01 to 10% by weight, preferably from 0.1 to 2% by weight, based on the amount of the batter.

As the starch which can be used in the batter, a cereal flour is preferably used, and examples thereof include wheat flour, corn flour, barley flour, buckwheat flour, potato flour, soybean flour, red bean flour, barnyard grass flour, foxtail millet flour, and proso millet flour, and particularly, rice flour is more preferably used. In addition, a starch such as tapioca starch, high-amylose starch, potato starch, corn starch, or waxy corn starch, a pregelatinized starch, and a processed starch such as an oxidized starch can also be used. The starch can be blended in an amount of from 0 to 70% by weight, based on the amount of the batter. The starch is sometimes added when the strength of the browned surface of gyoza is increased, and in order to ensure an appropriate viscosity on the browned surface, more preferably, the starch can be blended in an amount of from 1 to 30% by weight, based on the amount of the batter.

The protein which can be used in the batter is not particularly limited as long as it is an edible protein, however, for example, egg white, plasma powder, purified fish protein, purified soybean protein, erythrocyte powder, purified wheat protein, cell protein, milk protein, or gelatin can be used, preferably egg white, plasma powder, purified fish protein, purified soybean protein, or erythrocyte powder, each of which has adhesiveness, is used, and more preferably egg white is used. The protein can be blended in an amount of from 0 to 20% by weight, preferably from 0.3 to 3% by weight, based on the amount of the batter.

The seasoning which can be used in the batter is not particularly limited, however, a seasoning which facilitates the browning of the surface or a seasoning which provides a savory flavor when being baked can be used, and examples thereof include soy sauce, mirin (sweet sake), lactose, miso (fermented soybean paste), and Worcestershire sauce. The seasoning can be blended in an amount of from 0 to 30% by weight, preferably from 0.1 to 5% by weight, based on the amount of the batter.

In the case where the batter is composed of at least water, a cooking oil, an emulsifier, a starch, and a protein, the blending ratio (weight ratio) of the constituent components can be set to 10 to 99%:0 to 90%:0.01 to 10%:0 to 70%:0 to 20%, preferably 30 to 90%:0 to 60%:0.1 to 2%:1 to 30%:0.3 to 3%, based on the amount of the batter. In the case where the batter is composed of at least water, a cooking oil, an emulsifier, a starch, a protein, and a seasoning, the blending ratio (weight ratio) of the constituent components can be set to 10 to 99%:0 to 90%:0.01 to 10%:0 to 70%:0 to 20%:0 to 30%, preferably 30 to 90%:0 to 60%:0.1 to 2%:1 to 30%:0.3 to 3%:0.1 to 5%, based on the amount of the batter.

The frozen gyoza of the present invention may be produced by performing quick-freezing after browning a surface. The quick-freezing may be performed using, for example, a spiral freezer. The produced frozen gyoza is preferably stored at −5° C. or lower, and from the viewpoint of prevention of decrease in quality, it is preferably stored at −18° C. or lower.

Also, the refrigerated gyoza of the present invention may be produced by performing quick-refrigeration after browning a surface. The quick-refrigeration can be performed using, for example, a vacuum refrigerating machine, an air-cooled refrigerating machine, or a water-cooled refrigerating machine. The quick-refrigeration may also be performed by refrigeration to 10° C. or lower according to a conventional method. The produced refrigerated gyoza is preferably stored at 5° C. or lower.

Frozen Gyoza and Refrigerated Gyoza with Browning Agent

According to the invention, frozen or refrigerated gyoza with a browning agent, characterized in that the number of connection points in a net-like structure per unit area (mm²) (a structure value A) of a browning agent when the thickness of a section of the browning agent is set to 20 μm is from 20 to 90, and the sum of the lengths of center lines of structural bodies of the net-like structure per unit area (mm²) (a structure value B) of the browning agent when the thickness of a section of the browning agent is set to 20 is 30 mm or less, is provided. The frozen or refrigerated gyoza with a browning agent of the invention is unprecedented frozen or refrigerated gyoza with a browning agent having a high quality in the points that burnt debris generated when cooking the gyoza by steam-baking is reduced, the occurrence of an unbaked portion of the browning agent is prevented, and also a browned surface with a favorable texture is formed when cooking the gyoza by steam-baking.

In the frozen or refrigerated gyoza of the invention, the structure value A of the browning agent when the thickness of a section of the browning agent is set to 20 μm is preferably in a range of from 20 to 80, more preferably from 22 to 70, and/or the structure value B of the browning agent when the thickness of a section of the browning agent is set to 20 μM is preferably in a range of from 5 to 30, more preferably from 8 to 30. The measurement of the structure values A and B of the net-like structure can be performed according to the measurement method described with respect to the production method of the invention.

As the “browning agent” constituting the frozen or refrigerated gyoza with a browning agent of the invention, one described with respect to the production method of the invention can be used. Further, the frozen or refrigerated gyoza with a browning agent of the invention can be produced according to the production method of the invention, however, the method is not limited thereto.

Other features of the invention will become apparent in the course of the following descriptions of exemplary embodiments which are given for illustration of the invention and are not intended to be limiting thereof.

### EXAMPLES

### Example 1

### Relationship Among Composition of Browning Agent and Quality of Gyoza and Structure of Browned Surface

In this Example, an examination was made as to how the occurrence of an unbaked portion of the browning agent, the generation of burnt debris, and the texture of gyoza varied when frozen gyoza with a browning agent prepared using an emulsified batter (provided that a batter was used in an experimental group 3) having a different composition was cooked. Further, in order to examine the association between the quality of gyoza and the browning agent, a frozen section of the browning agent was observed with a microscope, and the structure thereof was analyzed.

### (1) Composition of Browning Agent.

In the browning agent, the ingredients of the composition shown in each of the experimental groups 1 to 10 in Table 1 were used.

TABLE 1

| | | | | Lighter- | | Casein | |
|---|---|---|---|---|---|---|---|
| | | | | colored soy | Egg white | sodium | |
| | Water | Salad oil | MT01HH*¹ | sauce | powder | salt | Lecithin |
| Experimental | 746.8 | 186.7 | 10 | 32.4 | 4 | 11.9 | 8.2 |
| group 1 | | | | | | | |
| Experimental | 186.7 | 746.8 | 10 | 32.4 | 4 | 11.9 | 8.2 |
| group 2 | | | | | | | |
| Experimental | 893.5 | 0 | 50 | 32.4 | 4 | 11.9 | 8.2 |
| group 3 | | | | | | | |
| Experimental | 357.4 | 536.1 | 50 | 32.4 | 4 | 11.9 | 8.2 |
| group 4 | | | | | | | |
| Experimental | 506.1 | 337.4 | 100 | 32.4 | 4 | 11.9 | 8.2 |
| group 5 | | | | | | | |
| Experimental | 168.7 | 674.8 | 100 | 32.4 | 4 | 11.9 | 8.2 |
| group 6 | | | | | | | |
| Experimental | 674.8 | 168.7 | 100 | 32.4 | 4 | 11.9 | 8.2 |
| group 7 | | | | | | | |
| Experimental | 297.4 | 446.1 | 200 | 32.4 | 4 | 11.9 | 8.2 |
| group 8 | | | | | | | |
| Experimental | 514.8 | 128.7 | 300 | 32.4 | 4 | 11.9 | 8.2 |
| group 9 | | | | | | | |
| Experimental | 386.1 | 257.4 | 300 | 32.4 | 4 | 11.9 | 8.2 |
| group 10 | | | | | | | |

(unit: g)
*¹tapioca starch acetate, manufactured by Nihon Shokuhin Kako Co., Ltd.

(2) Preparation of Gyoza with Browning Agent.

The ingredients of the composition shown in Table 1 were stirred at 6400 rpm for 4 minutes using ULTRA-TURRAX T50 Basic (manufactured by IKA-Werke GmbH & Co. KG), whereby an emulsified batter liquid (a browning agent liquid) was obtained. The obtained emulsified batter liquid was poured in a tray for gyoza in an amount of 2 g per gyoza dumpling. In this tray, meat gyoza (manufactured by Ajinomoto Frozen Foods Co., Inc.) was placed, and steam-heating was performed at 90° C. for 9 minutes. Then, the steamed gyoza was quickly frozen immediately thereafter, whereby frozen gyoza with a browning agent was prepared.

### (3) Evaluation of Steam-Heating and Sensory Evaluation.

In order to evaluate the quality of gyoza, the frozen gyoza obtained in the above (2) was arranged on a hot plate set at 240° C. Then, a lid was put on the plate and the gyoza was steam-baked for 4 minutes. After completion of steam-baking, in order to evaluate the degree of baking, (evaluation of steam-baking), the “amount of an unbaked portion of the browning agent” and the “amount of burnt debris of the browning agent” remaining on the hot plate were evaluated. Further, a sensory evaluation for the “texture when eating” was also performed. The evaluation criteria of each evaluation item were set as shown in Table 2. The scores in Table 2 were set stepwise in each evaluation item such that 5 is the best score and as the score decreases and approaches 1, the rating decreases.

TABLE 2

| Amount of | Amount of | |
|---|---|---|
| unbaked portion | burnt debris of | |
| of emulsified batter | emulsified batter | Texture when eating |
| 5: No unbaked | 5: No burnt debris is | 5: Gyoza has an |
| portion occurs. | generated. | excellent crisp |
| | | texture. |
| 4: A slight unbaked | 4: Slight burnt debris | 4: Gyoza has a |
| portion occurs | is generated but is | good crisp |
| but is not | not bothersome. | texture. |
| bothersome. | | |
| 3: An unbaked | 3: Burnt debris | 3: Gyoza has a |
| portion is | is slightly | crisp texture |
| slightly bothersome. | bothersome. | but the texture |
| | | is not good. |
| 2: Unbaked portions | 2: Burnt debris is | 2: Gyoza has a |
| are connected | bothersome. | weak crisp |
| and bothersome. | | texture and the |
| | | texture is |
| | | unfavorable. |
| 1: The batter is | 1: Too much burnt | 1: Gyoza has no |
| not baked. | debris is | crisp texture and |
| | generated. | the texture |
| | | disinclines you |
| | | to eat. |

### (4) Preparation of Frozen Section of Browning Agent.

In order to observe the structure of the browning agent using a microscope, the browning agent of the gyoza after the steam-heating treatment obtained in the above (2) was frozen, cut into a section with a size of 1 cm×1 cm, and then, fixed for 24 hours in a Ufix solution (manufactured by Sakura Finetek Co., Ltd.) at −25° C. Then, the fixed browning agent was degreased by being immersed in 100% hexane at −25° C. for 18 hours. Thereafter, the degreased browning agent was added to a solution containing 10% sucrose and a 1% iodine solution at 4° C. and immersed therein for 18 hours, so that the replacement of the sugar solution in the browning agent and the staining of the starch therein were performed. In order to allow the replacement of the sugar solution to further proceed, the browning agent was immersed in a solution containing 15% sucrose and a 1% iodine solution at 4° C. for 8 hours, and then, immersed in a 20% sucrose solution at 4° C. for 18 hours. Finally, the browning agent was embedded in 4% carboxymethyl cellulose and frozen at −25° C., and then, a frozen section with a thickness of 20 μm was prepared using a microtome.

### (5) Observation and Image Analysis of Frozen Section.

The frozen section of the browning agent prepared in the above (4) was air-dried on a slide glass. The frozen section was observed using a light microscope (at a magnification of 40 times), and an image thereof was taken. The image analysis of the frozen section was performed using 3D-BON trabecular bone structure analysis software (manufactured by Ratoc System Engineering Co., Ltd.) and applying 2-D bone analysis of the trabecular bone structure analysis according to a given manual. Specifically, first, the obtained image was subjected to Binarize Auto LW, followed by fine adjustment, thereby binarizing the image. Then, the noise was removed from the structure portion of the browning agent under the conditions of “2D Ero”→“Ers 5 ml 50 μm”→“2D Dil”. By using the above-described software, the frozen section of the browning agent was analyzed under the conditions of NdNd effective length (1.500× thickness) and Nd™ effective length (2.000× thickness), and the following parameters were evaluated as the indices of the structure of the browned surface of gyoza.

Structure value A: the number (points/mm²) of connection points (bonding points) in the net-like structure per unit area (mm²)

Structure value B: the sum (mm/mm²) of the lengths of center lines of structural bodies of the net-like structure per unit area (mm²)

An average (n=3) of each structure value was obtained and used as the structure value of each browning agent.

Incidentally, it was confirmed that the net-like structure observed in the frozen section was mainly composed of a starch and a protein (data omitted).

### (6) Results.

The results of the evaluation of steam-baking, the sensory evaluation, and the image analysis of the structure of the browned surface were as shown in Table 3.

TABLE 3

| | Structure | Structure | Unbaked | | |
|---|---|---|---|---|---|
| | value A | value B | portion | Burnt debris | Texture |
| Experimental | 30.68 | 20.68 | 5 | 4 | 4 |
| group 1 | | | | | |
| Experimental | 3.27 | 48.67 | 5 | 5 | 2 |
| group 2 | | | | | |
| Experimental | 10.72 | 10.54 | 5 | 5 | 2 |
| group 3 | | | | | |
| Experimental | 25.26 | 16.33 | 5 | 5 | 5 |
| group 4 | | | | | |
| Experimental | 24.25 | 25.08 | 5 | 5 | 5 |
| group 5 | | | | | |
| Experimental | 10.42 | 34.60 | 4 | 3 | 4 |
| group 6 | | | | | |
| Experimental | 10.28 | 30.90 | 5 | 4 | 2 |
| group 7 | | | | | |
| Experimental | 17.59 | 32.42 | 2 | 5 | 1 |
| group 8 | | | | | |
| Experimental | 18.72. | 42.90 | 1 | 5 | 1 |
| group 9 | | | | | |
| Experimental | 20.20 | 35.17 | 1 | 5 | 1 |
| group 10 | | | | | |

As shown in Table 3, in the case where the structure value A of the frozen section of the browning agent was 20 or less (the experimental groups 2, 3, and 6 to 9) or the structure value B was 30 or more (the experimental groups 2, and 6 to 10), a tendency was observed that either of the result of evaluation of steam-baking and the result of sensory evaluation of texture was 3 or less, and in the case where the structure value A was 20 or more and the structure value B was 30 or less (the experimental groups 1, 4, and 5), for both of the evaluation of steam-baking and the sensory evaluation, a high score of 4 or more was obtained and the quality of gyoza was high.

### Example 2

### Relationship Among Type of Starch to be Used in Browning Agent and Quality of Gyoza and Structure of Browned Surface

In this Example, the preparation of frozen gyoza with a browning agent, the evaluation of steam-baking, the sensory evaluation, the preparation of a frozen section of the browning agent, and the observation and image analysis of the frozen section were performed using the same compositions and methods as in Example 1 except that Roadster (manufactured by Nihon Shokuhin Kako Co., Ltd.), which is a hygrothermally treated high-amylose corn starch, was used as the starch in the browning agent.

The results of the evaluation of steam-baking, the sensory evaluation, and the image analysis of the structure of the browned surface when using Roadster as the starch in the browning agent were as shown in Table 4.

TABLE 4

| | Structure | Structure | Unbaked | | |
|---|---|---|---|---|---|
| | value A | value B | portion | Burnt debris | Texture |
| Experimental | 37.73 | 13.68 | 5 | 4 | 4 |
| group 11 | | | | | |
| Experimental | 22.87 | 33.12 | 5 | 3 | 4 |
| group 12 | | | | | |
| Experimental | 32.88 | 13.84 | 5 | 4 | 4 |
| group 13 | | | | | |
| Experimental | 32.10 | 22.00 | 4 | 4 | 4 |
| group 14 | | | | | |
| Experimental | 22.62 | 28.90 | 4 | 4 | 5 |
| group 15 | | | | | |
| Experimental | 7.95 | 25.88 | 4 | 2 | 4 |
| group 16 | | | | | |
| Experimental | 47.10 | 19.08 | 5 | 5 | 4 |
| group 17 | | | | | |
| Experimental | 38.21 | 33.17 | 2 | 4 | 2 |
| group 18 | | | | | |
| Experimental | 26.90 | 32.67 | 1 | 5 | 1 |
| group 19 | | | | | |
| Experimental | 10.42 | 20.54 | 1 | 5 | 1 |
| group 20 | | | | | |

As shown in Table 4, even when the starch was changed, in the case where the structure value A of the frozen section of the browning agent was 20 or less (the experimental groups 16 and 20) or the structure value B was 30 or more (the experimental groups 12, 18, and 19), a tendency was observed that either of the result of evaluation of steam-baking and the result of sensory evaluation was 3 or less, and in the case where the structure value A was 20 or more and the structure value B was 30 or less (the experimental groups 11, 13 to 15, and 17), for both of the evaluation of steam-baking and the sensory evaluation, a high score of 4 or more was obtained.

As described above, according to Examples 1 and 2, an apparent correlation between the structure values A and B of the frozen section of the browning agent and the evaluation of steam-baking and the sensory evaluation was observed, and it was shown that in the case where the structure value A was 20 or more and the structure value B was 30 or less, high evaluation results were obtained for both evaluation items, and the quality of gyoza was improved. Further, a tendency of correlation between the structure of the browning agent and the evaluation of steam-baking and the sensory evaluation did not depend on the type of starch to be used in the browning agent.

However, it was shown that depending on the type of starch to be used in the browning agent, an effect was observed on the evaluation of steam-baking, the sensory evaluation, or the structure of the browned surface (for example, the experimental groups 3 and 13 or the experimental groups 7 and 17).

### Example 3

### Relationship Among Type of Starch to be Used in Browning Agent and Quality of Gyoza and Structure of Browned Surface

In this Example, an examination was made as to how the occurrence of an unbaked portion of the browning agent, the generation of burnt debris, and the texture of gyoza varied depending on the relationship with the structure values A and B when gyoza was produced using a browning agent prepared using a different starch and the thus produced gyoza was cooked. Specifically, in this Example, the preparation of frozen gyoza with a browning agent, the evaluation of steam-baking, the sensory evaluation, the preparation of a frozen section of the browning agent, and the observation and image analysis of the frozen section were performed in the same manner as in Example 1 except that the composition of the browning agent and the type of starch to be used in the browning agent were changed. In the browning agent of this Example, the ingredients shown in each of the experimental groups in Table 5 were used, and the starches used in the browning agent were as shown in Table 6.

TABLE 5

| | | | Lighter- | Egg | Casein | |
|---|---|---|---|---|---|---|
| | | | colored soy | white | sodium | |
| Water | Salad oil | Starch | sauce | powder | salt | Lecithin |
| 357.4 | 536.1 | 50 | 32.4 | 4 | 11.9 | 8.2 |

(unit: g)

TABLE 6

| | |
|---|---|
| Experimental | MD starch (waxy corn starch, manufactured by Nihon |
| group 21 | Shokuhin Kako Co., Ltd.) |
| Experimental | Corn starch (manufactured by Nihon Shokuhin Kako |
| group 22 | Co., Ltd.) |
| Experimental | Non-glutinous rice flour (manufactured by Gunmaseifun |
| group 23 | Flour Milling Co., Ltd.) |
| Experimental | Stabilose K (oxidized starch, manufactured by Matsutani |
| group 24 | Chemical Industry Co., Ltd.) |
| Experimental | Potato starch (manufactured by Matsutani Chemical |
| group 25 | Industry Co., Ltd.) |

The results of the evaluation of steam-baking, the sensory evaluation, and the image analysis of the structure of the browned surface were as shown in Table 7.

TABLE 7

| | Structure | Structure | Unbaked | | |
|---|---|---|---|---|---|
| | value A | value B | portion | Burnt debris | Texture |
| Experimental | 35.17 | 14.61 | 5 | 4 | 4 |
| group 21 | | | | | |
| Experimental | 8.92 | 12.45 | 5 | 3 | 4 |
| group 22 | | | | | |
| Experimental | 57.30 | 28.29 | 4 | 5 | 5 |
| group 23 | | | | | |
| Experimental | 25.06 | 25.17 | 5 | 4 | 4 |
| group 24 | | | | | |
| Experimental | 33.70 | 12.15 | 5 | 4 | 4 |
| group 25 | | | | | |

As shown in Table 7, in all the experimental groups except for the experimental group 22, the structure value A was 20 or more and the structure value B was 30 or less, and for both of the evaluation of steam-baking and the sensory evaluation, a high score of 4 or more was obtained. Meanwhile, in the experimental group 22, the structure value A was 20 or less, and the score of the evaluation of steam-baking resulted in 3 or less.

### Example 4

### Effect of Method for Preparing Browning Agent on Quality of Gyoza

In this Example, the effect of the method for preparing the browning agent on the quality of gyoza was examined. Specifically, in this Example, the preparation of frozen gyoza with a browning agent, the evaluation of steam-baking, the sensory evaluation, the preparation of a frozen section of the browning agent, and the observation and image analysis of the frozen section were performed in the same manner as in Example 1 except that the composition of the browning agent and the stirring conditions were changed.

In the browning agent of this Example, the ingredients shown in each of the experimental groups in Table 8 were used, and the stirring conditions when preparing the browning agent were set as shown in Table 8. In this Example, the stirring of the ingredients of the browning agent was performed using ULTRA-TURRAX T50 Basic (manufactured by IKA-Werke GmbH & Co. KG), and the stirring conditions were set in two ways: “strong” (10,000 rpm, 5 minutes) and “medium” (6,400 rpm, 4 minutes).

TABLE 8

| | | | | Lighter-colored | Egg white | Casein | | Stirring |
|---|---|---|---|---|---|---|---|---|
| | Water | Salad oil | | soy sauce | powder | sodium salt | Lecithin | conditions |
| | | | Roadster | | | | | |
| Experimental group | 337.4 | 506.1 | 100 | 32.4 | 4 | 11.9 | 8.2 | Medium |
| 26 | | | | | | | | |
| Experimental group | 337.4 | 506.1 | 100 | 32.4 | 4 | 11.9 | 8.2 | Strong |
| 27 | | | | | | | | |
| | | | Rice flour*² | | | | | |
| Experimental group | 373.4 | 560.1 | 10 | 32.4 | 4 | 11.9 | 8.2 | Medium |
| 28 | | | | | | | | |
| Experimental group | 373.4 | 560.1 | 10 | 32.4 | 4 | 11.9 | 8.2 | Strong |
| 29 | | | | | | | | |
| Experimental group | 357.4 | 536.1 | 50 | 32.4 | 4 | 11.9 | 8.2 | Medium |
| 23 | | | | | | | | |
| Experimental group | 357.4 | 536.1 | 50 | 32.4 | 4 | 11.9 | 8.2 | Strong |
| 30 | | | | | | | | |

(unit: g)
*²non-glutinous rice flour

The results of the evaluation of steam-baking, the sensory evaluation, and the image analysis were as shown in Table 9.

TABLE 9

| | Structure | Structure | Unbaked | | |
|---|---|---|---|---|---|
| | value A | value B | portion | Burnt debris | Texture |
| Experimental | 19.78 | 7.74 | 4 | 3 | 3 |
| group 26 | | | | | |
| Experimental | 29.77 | 10.83 | 4 | 4 | 4 |
| group 27 | | | | | |
| Experimental | 15.42 | 5.58 | 5 | 3 | 4 |
| group 28 | | | | | |
| Experimental | 67.35 | 18.92 | 5 | 4 | 4 |
| group 29 | | | | | |
| Experimental | 57.30 | 28.29 | 4 | 5 | 5 |
| group 23 | | | | | |
| Experimental | 96.26 | 23.73 | 3 | 4 | 3 |
| group 30 | | | | | |

As shown in Table 9, it was found that when the stirring conditions at the time of mixing the ingredients of the browning agent were changed, the structure value A was significantly changed. Specifically, it was found that by increasing the stirring intensity, the structure value A tended to be increased, in other words, the number of connection points (bonding points) of the net-like structure of the browning agent tended to be increased. For example, by comparing FIG. 2A (the experimental group 26) and FIG. 2B (the experimental group 27), it is found that in the experimental group 27, the structure value A is significantly increased by increasing the stirring intensity. Further, by comparing FIG. 2C (the experimental group 30) and FIG. 2D (the experimental group 23), it is found that in the experimental group 23, the structure value A is significantly decreased by decreasing the stirring intensity. In addition, in the same manner as in Examples 1 to 3, in the case where the structure value A was 20 or less (the experimental groups 26 and 28), a score of 3 or less was obtained for either of the evaluation of baking and the sensory evaluation. Further, also in the case where the structure value A was increased and exceeded 90 (the experimental group 30), an adverse effect was observed on the evaluation of baking and the sensory evaluation. From these results, it was found that the structure value A can be increased by increasing the stirring intensity, and the structure value A is preferably 90 or less.

From these results, it was found that the structure value A of the frozen section of the browning agent is preferably 20 or more and 90 or less, and the structure value B is preferably 30 or less.

### Example 5

### Effect of Production Conditions for Gyoza on Quality of Gyoza

In this Example, an examination was made as to what factors had an effect on the quality of gyoza other than the composition of the browning agent.

Specifically, in this Example, the preparation of frozen gyoza with a browning agent, the evaluation of steam-baking, the sensory evaluation, the preparation of a frozen section of the browning agent, and the observation and image analysis of the frozen section were performed in the same manner as in Example 3 except that the experimental group 22 in Example 3 was used as a control, and the stirring conditions for the browning agent and the steaming conditions for gyoza were changed.

In this Example, the stirring conditions for the browning agent and the steaming conditions for gyoza were set as shown in Table 10. The stirring of the ingredients of the browning agent was performed using ULTRA-TURRAX T50 Basic (manufactured by IKA-Werke GmbH & Co. KG), and the mixing by hand was performed using a whisk.

TABLE 10

| | | Steaming |
|---|---|---|
| | Stirring conditions | conditions |
| Experimental | 6,400 rpm, 4 minutes | 90° C., 9 minutes |
| group 22 | | |
| Experimental | Mixing by hand (whisk), 3 | 65° C., 5 minutes |
| group 31 | minutes | |
| Experimental | 10,000 rpm, 5 minutes | 95° C., 15 minutes |
| group 32 | | |

The results of the evaluation of steam-baking, the sensory evaluation, and the image analysis were as shown in Table 11.

TABLE 11

| | Structure | Structure | Unbaked | | |
|---|---|---|---|---|---|
| | value A | value B | portion | Burnt debris | Texture |
| Experimental | 8.92 | 12.45 | 5 | 3 | 4 |
| group 22 | | | | | |
| Experimental | 25.78 | 9.75 | 5 | 4 | 5 |
| group 31 | | | | | |
| Experimental | 30.72 | 11.18 | 4 | 4 | 4 |
| group 32 | | | | | |

As shown in Table 11, in the experimental group 31, the stirring intensity was lower than in the experimental group 22 (under the conditions that the structure value A was decreased), however, since the steaming conditions were set to low, the structure value A was increased to 20 or more. In addition, the amount of burnt debris, which was not favorable in the experimental group 22, was decreased in the experimental group 31, and a score of 4 or more was obtained for both of the evaluation of steam-baking and the sensory evaluation. From these results, it was found that by setting the steaming conditions for gyoza to low, the structure value A of the browning agent after steam-baking was increased. Further, in the experimental group 32, the stirring intensity was higher than in the experimental group 22 (under the conditions that the structure value A was increased), however, by using the steaming conditions which were set to higher than in the experimental group 22 (under the conditions that the structure value A was decreased), the structure values A and B of the structure of the browned surface of gyoza were adjusted so that the structure value A was 20 or more and 90 or less and the structure value B was 30 or less. As a result, in the experimental group 32, a score of 4 or more was obtained for both of the evaluation of steam-baking and the sensory evaluation.

In this manner, by changing the production conditions such as the stirring conditions for the browning agent or the steam-heating conditions for gyoza, it was possible to prepare gyoza such that the structure value A of the frozen section of the browning agent was 20 or more and 90 or less and the structure value B was 30 or less, and the quality of the obtained gyoza could be improved.

### Example 6

### Other Production Conditions that Affect Structure of Browning Agent

In this Example, the effect of the ratio of water to oil to be used as the ingredients of the browning agent and the effect of the temperature when mixing the ingredients on the structure of the browning agent were examined.

In this Example, frozen gyoza with a browning agent was prepared in the same manner as in Example 1 except that the composition of the browning agent was changed as shown in Table 12 (an experimental group 33). Further, the preparation of a frozen section of the browning agent and the observation and image analysis of the frozen section were performed in the same manner as in Example 1. The structure of the browning agent of the obtained gyoza was analyzed, and it was found that the structure value A was 27.66 and the structure value B was 13.35.

TABLE 12

| | | | Non- | Lighter- | | | |
|---|---|---|---|---|---|---|---|
| | | | glutinous | colored | Egg | Casein | |
| | Wa- | Salad | rice | soy | white | sodium | |
| | ter | oil | flour | sauce | powder | salt | Lecithin |
| Experi- | 357.4 | 536.1 | 50 | 32.4 | 4 | 11.9 | 8.2 |
| mental | | | | | | | |
| group | | | | | | | |
| 33 | | | | | | | |

(unit: g)

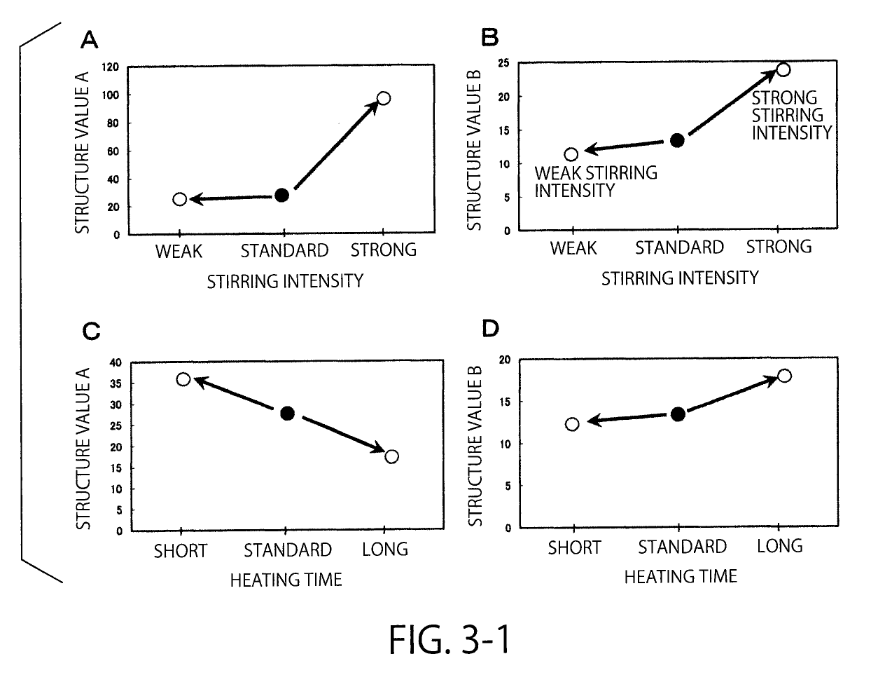

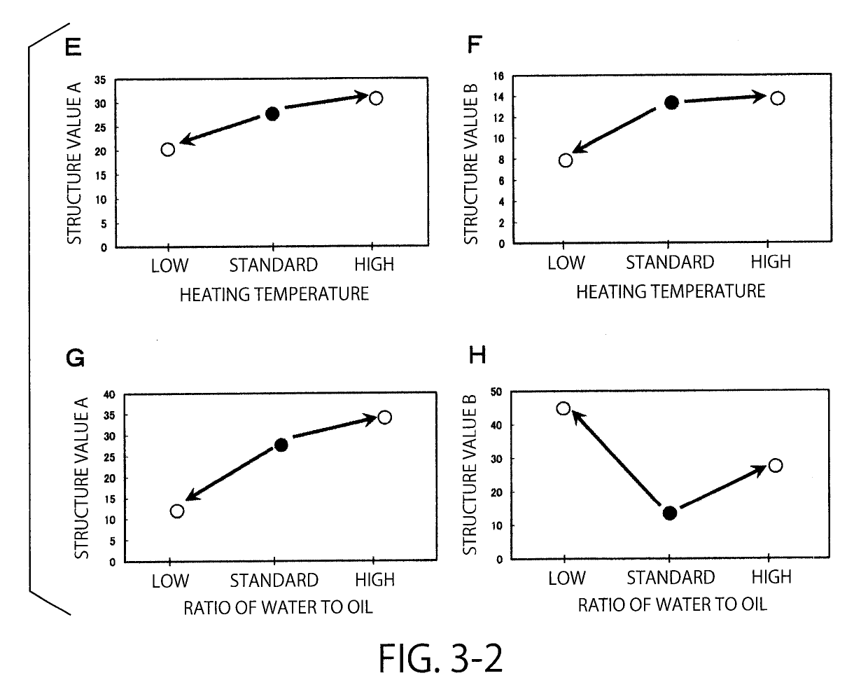

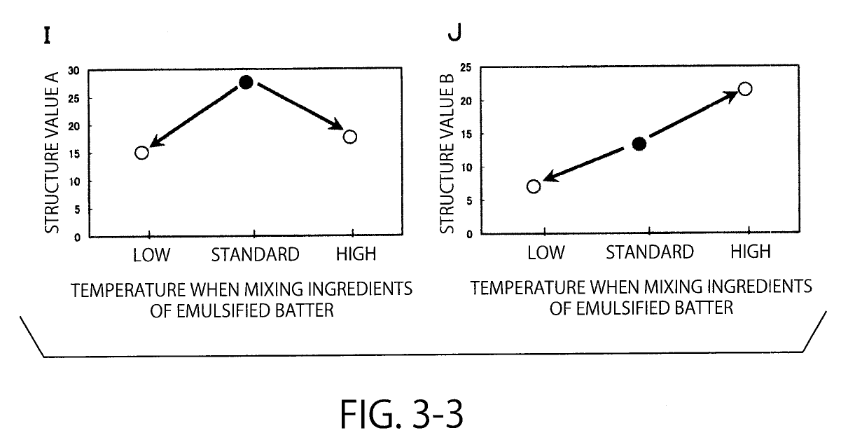

The preparation of frozen gyoza with a browning agent, the preparation of a frozen section of the browning agent, and the observation and image analysis of the frozen section were performed in the same manner as in the experimental group 33, however, an examination was made as to how the structure values A and B of the frozen section of the browning agent of the obtained frozen gyoza varied in the case where only the stirring conditions when preparing the browning agent was changed (FIGS. 3A and 3B), in the case where only the steam-heating time for gyoza was changed (FIGS. 3C and 3D), in the case where only the steam-heating temperature for gyoza was changed (FIGS. 3E and 3F), in the case where only the ratio of water to oil in the browning agent was changed (FIGS. 3G and 3H), or in the case where only the temperature when mixing the ingredients of the browning agent was changed (FIGS. 3I and 3J). The tendencies of the variations are shown in FIGS. 3A to 3J.

It was found that when the stirring intensity was increased, both of the structure values A and B tended to be increased, and when the stirring intensity was decreased, both of the structure values A and B tended to be decreased (see FIGS. 3A and 3B).

Further, it was found that when the steam-heating time for gyoza was increased, the structure value A was decreased but the structure value B was increased, and when the steam-heating time for gyoza was decreased, the structure value A was increased but the structure value B was decreased (see FIGS. 3C and 3D).

Further, it was found that when the steam-heating temperature for gyoza was increased, both of the structure values A and B tended to be increased, and when the steam-heating temperature for gyoza was decreased, both of the structure values A and B tended to be decreased (see FIGS. 3E and 3F).

Still further, it was found that when the ratio of water to oil in the browning agent was increased, both of the structure values A and B tended to be increased, and when the ratio of water to oil in the browning agent was decreased, the structure value A tended to be decreased but the structure value B tended to be increased (see FIGS. 3G and 3H).

Still further, it was found that when the temperature at the time of mixing the ingredients of the browning agent was increased, the structure value A tended to be decreased but the structure value B tended to be increased, and when the temperature at the time of mixing the ingredients of the browning agent was decreased, both of the structure values A and B tended to be decreased (see FIGS. 3I and 3J).

In this manner, in the present invention, by changing the composition of the browning agent or the production conditions for the browning agent, and/or by changing the production conditions for gyoza, the structure of the frozen section of the browning agent can be controlled, and as a result, the quality of gyoza can be improved.

Accordingly, from the results of this Example, it was found that in the case where the structure values A and B of the frozen section of the browning agent do not satisfy the predetermined conditions, by taking the measures shown in FIG. 4 so as to adjust the structure values A and B, the quality of gyoza can be improved.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A method for producing frozen or refrigerated gyoza with a browning agent, characterized in that a browning agent is prepared using a net-like structure of the browning agent as an index.

2. A method according to claim 1, wherein the number of connection points in the net-like structure per unit area, points/mm², a structure value A, of the browning agent and the sum of the lengths of center lines of structural bodies of the net-like structure, mm, per unit area, mm², structure value B, of the browning agent are controlled.

3. A method according to claim 2, wherein a sample of said browning agent, which has a thickness of 20 μm, has a structure value A of from 20 to 90 points/mm².

4. A method according to claim 2, wherein a sample of said browning agent, which has a thickness of 20 μm, has a structure value B of 30 (mm/mm²) or less.

5. A method according to claim 3, wherein a sample of said browning agent, which has a thickness of 20 μm, has a structure value B of 30 (mm/mm²) or less.

6. Frozen or refrigerated gyoza with a browning agent, produced by a method according to claim 1.

7. Frozen or refrigerated gyoza with a browning agent, produced by a method according to claim 2.

8. Frozen or refrigerated gyoza with a browning agent, produced by a method according to claim 3.

9. Frozen or refrigerated gyoza with a browning agent, produced by a method according to claim 4.

10. Frozen or refrigerated gyoza with a browning agent, produced by a method according to claim 5.

11. Frozen or refrigerated gyoza with a browning agent, wherein said browning agent has a net-like structure, such that the number of connection points in said net-like structure per unit area, mm², structure value A, of a sample of said browning agent, which has a thickness of 20 μm, is from 20 to 90 points/mm², and the sum of the lengths of center lines of structural bodies of said net-like structure per unit area, mm², structure value B, of a sample of said browning agent having a thickness of 20 μm, is 30 nm⁻¹ or less.
